(19) United States
(12) Patent Application Publication
(10) Pub. No.: US 2024/0299786 A1
(43) Pub. Date: Sep. 12, 2024

(54) HYDROGEN FLAME ARRESTOR

(71) Applicant: Caterpillar Inc., Peoria, IL (US)

(72) Inventors: Christopher Ronald GEHRKE, Chillicothe, IL (US); Ryan SNODGRASS, Fowler, IN (US); Patrick SEILER, Peoria, IL (US); Kevin WOBSCHALL, West Lafayette, IN (US)

(73) Assignee: Caterpillar Inc., Peoria, IL (US)

(21) Appl. No.: 18/119,655

(22) Filed: Mar. 9, 2023

(51) Int. Cl. A62C 4/00; A62C 3/06

(52) U.S. Cl. CPC A62C 4/00; A62C 3/06

(57) ABSTRACT

In an internal combustion engine, the use of natural gas containing hydrocarbon or hydrogen may result in backfires into the intake manifold. Thus, a flame arrestor is disclosed for insertion into intake runners of the intake manifold. The flame arrestor may comprise at least two substrates, separated by an internal air gap of 3-9 millimeters (e.g., substantially 4 millimeters). The substrates may each comprise a metallic mesh with channels. The channel of one substrate may be unaligned with the channels of the other substrate. The internal air gap and/or unaligned channels of the disclosed flame arrestor effectively quench backfires into the intake runners.

### TECHNICAL FIELD

The embodiments described herein are generally directed to internal combustion engines, and, more particularly, to a hydrogen flame arrestor for the intake of an internal combustion engine.

### BACKGROUND

Natural gas engines operate similarly to diesel and gasoline engines. Natural gas provides several advantages over diesel and gasoline, such as a higher abundance, higher fuel efficiency, and lower noxious emissions. These advantages can be heightened by blending hydrogen into the natural gas supplied to the engine.

However, the addition of hydrogen to natural gas may lead to backfire in the intake runner to the engine, due to the low ignition energy of hydrogen. Thus, a flame arrestor is inserted in the intake runner to quench this backfire. Conventional flame arrestors generally use a catalyst substrate, such as disclosed in U.S. Pat. No. 5,375,565. Other examples of flame arrestors are described in Chinese Patent No. 110013627, Chinese Patent No. 110013628, European Patent No. 3082980, and U.S. Pat. No. 6,978,845.

The present disclosure is directed toward overcoming one or more of the problems discovered by the inventors.

### SUMMARY

In an embodiment, a flame arrestor comprises: a housing having a longitudinal axis from a first end to a second end; a first substrate within the housing at the first end, the first substrate comprising a plurality of channels from the first end towards the second end; and a second substrate within the housing at the second end, the second substrate comprising a plurality of channels from the second end towards the first end; wherein the second substrate is spaced apart from the first substrate, along the longitudinal axis, by an air gap within the housing.

In an embodiment, a flame arrestor comprises: a cylindrical housing having a longitudinal axis from a first end to a second end; a first substrate within the cylindrical housing at the first end, the first substrate comprising a plurality of channels from the first end towards the second end; and a second substrate within the cylindrical housing at the second end, the second substrate comprising a plurality of channels from the second end towards the first end; wherein the second substrate is spaced apart from the first substrate, along the longitudinal axis, by an air gap within the cylindrical housing, wherein a length of the air gap, along the longitudinal axis, is between 1 millimeter and 9 millimeters, and wherein the plurality of channels in the first substrate is unaligned with the plurality of channels in the second substrate.

In an embodiment, a method of manufacturing a flame arrestor comprises: splitting an existing flame arrestor, along a radial axis, into a first half and a second half, wherein the existing flame arrestor comprises a housing, having a longitudinal axis from a first end to a second end that is orthogonal to the radial axis, only a single substrate within the housing, a first spacing from the first end to the substrate, and a second spacing from the second end to the substrate; rotating both the first half and the second half, such that the first spacing is contiguous with the second spacing, so as to form an air gap, along the longitudinal axis, between the substrate in the first half and the substrate in the second half; and joining the housing of the rotated first half to the housing of the rotated second half to form a new flame arrestor.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 illustrates a machine with an internal combustion engine, according to an embodiment;

FIG. 2 illustrates a cross-sectional view of an intake runner with an installed flame arrestor, according to an embodiment;

FIG. 3 illustrates a view of the flame arrestor along its longitudinal axis, according to an embodiment;

FIG. 4 illustrates a cross-sectional view of the flame arrestor, orthogonal to its longitudinal axis, according to an embodiment;

FIG. 5 illustrates a portion of a substrate of the flame arrestor, according to an embodiment;

FIG. 6 illustrates a process for manufacturing the flame arrestor, according to an embodiment; and

FIGS. 7A-7C illustrate states of a flame arrestor during the manufacturing process, according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details. In some instances, well-known structures and components are shown in simplified form for brevity of description.

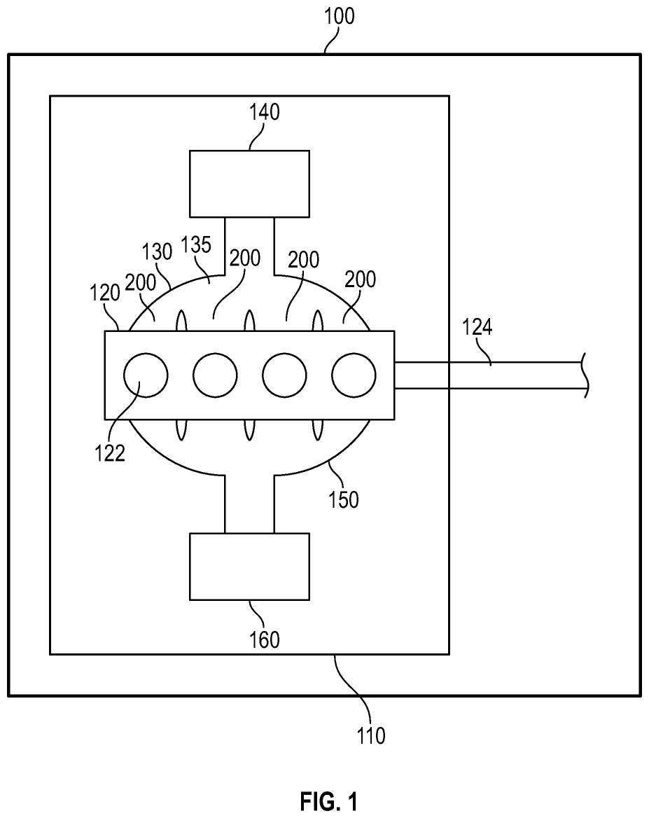

FIG. 1 illustrates a machine 100 with an internal combustion engine 110, according to an embodiment. Machine 100 may be mobile or stationary equipment. Examples of mobile equipment include, without limitation, an excavator, wheel loader, dump truck, asphalt paver, backhoe loader, skid steer, track loader, cold planer, compactor, dozer, electric rope shovel, forest machine, hydraulic mining shovel, material handler, motor grader, pipe-layer, road reclaimer, telehandler, tractor-scraper, or the like, as well as ordinary road vehicles (e.g., automobiles, semi-trucks, etc.), aircraft, or maritime vessels (e.g., boats, ships, etc.). Examples of stationary equipment include, without limitation, a power generator, a compressor, and the like. However, it should be understood that machine 100 may be any apparatus that is powered by an internal combustion engine 110.

Internal combustion engine 110 may comprise an engine block 120. Engine block 120 comprises a plurality of cylinders 122 that rotates a shaft 124, which drives machine 100. Internal combustion engine 110 may also comprise an intake manifold 130 that supplies a gas (e.g., air) from an intake system 140 to the interior of engine block 120. Intake manifold 130 comprises a plurality of intake runners 200 that each provide a channel between a plenum 135 of intake manifold 130 and the interior of engine block 120. Internal combustion engine 110 may also comprise an exhaust manifold 150 that channels exhaust, produced by combustion within engine block 120, to an exhaust system 160.

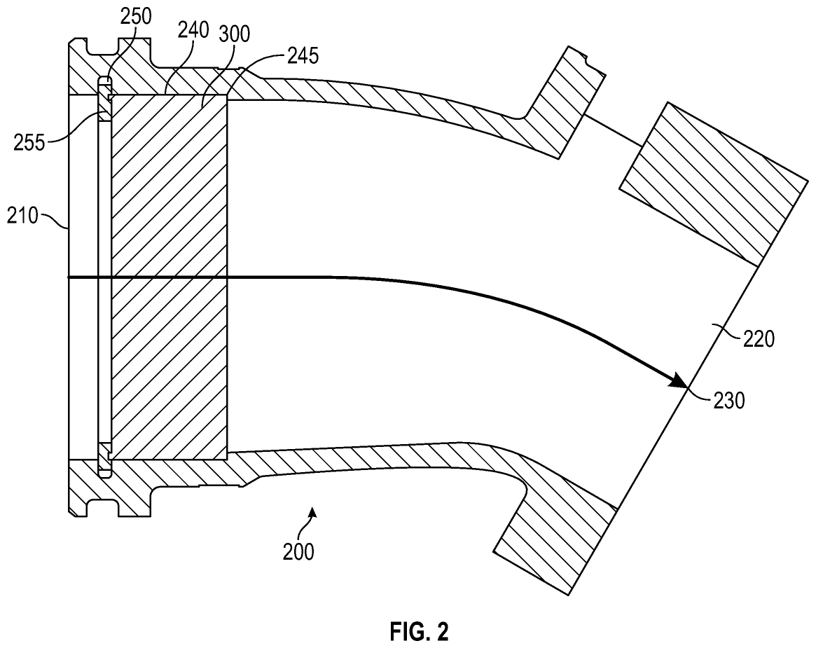

FIG. 2 illustrates a cross-sectional view of a single intake runner 200, according to an embodiment. Intake runner 200 comprises an inlet 210 and an outlet 220, and defines a channel 230 between inlet 210 and outlet 220. Inlet 210 is in fluid communication with plenum 135, and outlet 220 is in fluid communication with the interior of engine block 120. Thus, gas, such as air, within plenum 135 flows downstream from plenum 135 into inlet 210, through channel 230, and out of outlet 220 into engine block 120.

Intake runner 200 may receive backfire into channel 230 from engine block 120 through outlet 220. To prevent this backfire from flowing upstream through inlet 210 and into plenum 135, a flame arrestor 300 is installed in intake runner 200. In the illustrated embodiment, flame arrestor 300 is installed near inlet 210, and at least nearer to inlet 210 than outlet 220 along channel 230. However, flame arrestor 300 may be installed at a different position along channel 230.

Flame arrestor 300 may be installed within a circumferential recess 240 within the radially inner surface of intake runner 200. The diameter of recess 240 matches the outer diameter of flame arrestor 300, such that flame arrestor 300 can fit within recess 240 with minimal to no gap between the radially outer surface of flame arrestor 300 and the radially inner surface of intake runner 200 corresponding to recess 240. In addition, the diameter of recess 240 is greater than the diameter of the immediately downstream portion of channel 230, such that the downstream end of recess 240 has a lip 245 that extends radially inward. Lip 245 prevents flame arrestor 300 from sliding downstream within intake runner 200. Thus, during installation, flame arrestor 300 can be slid through inlet 210 into intake runner 200, until the downstream end of flame arrestor 300 abuts lip 245.

In an embodiment, the radially inner surface of intake runner 200 has a circumferential groove 250 at the upstream end of recess 240. The axial length of recess 240, which is defined by groove 250 on the upstream end and lip 245 on the downstream end, may be the same as the axial length of flame arrestor 300, such that flame arrestor 300 fits between groove 250 and lip 245 when installed within recess 240. After flame arrestor 300 has been installed in recess 240, a snap ring 255 may be inserted into groove 250, to thereby prevent flame arrestor 300 from sliding upstream. Thus, flame arrestor 300 is fixed into place within channel 230 by snap ring 255 and lip 245. Notably, gas flowing downstream through channel 230 must pass through flame arrestor 300. Similarly, any flame, backfiring upstream through channel 230, with the potential of reaching inlet 210, will have to pass through flame arrestor 300 in the opposite direction.

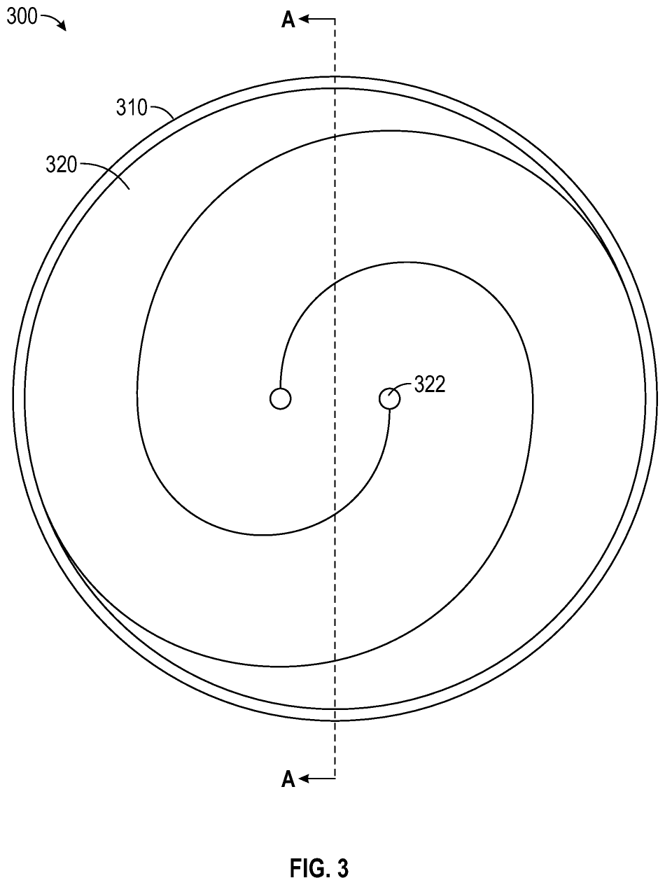

FIG. 3 illustrates a view of flame arrestor 300, along its longitudinal axis, according to an embodiment. As illustrated, flame arrestor 300 comprises a cylindrical housing 310 that surrounds two circular substrates 320. However, only a single substrate 320 is visible in FIG. 3. Each substrate 320 may be a catalyst substrate. The catalyst substrate may comprise or consist of a metallic mesh that provides a plurality of channels through which gas (e.g., air) can pass from one side of substrate 320 to the other side of substrate 320, but which quenches a flame by absorbing the heat from the flame front to drop the burning natural gas mixture below its auto-ignition temperature. In an embodiment, both housing 310 and substrate 320 are made from stainless steel. For example, housing 310 may be made from 1.4509 stainless steel, and substrate 320 may be made from 1.4767 stainless steel. The metallic mesh of substrate 320 may have a mesh density of 400 cells per square inch or greater.

As an artifact of the manufacturing process, each substrate 320 may comprise a pair of holes 322. These holes 322 may represent loops in a corrugated ribbon into which mandrels were inserted for spooling the corrugated ribbon, to thereby form the metallic mesh in the circular shape of substrate 320. It should be understood that the size of holes 322 may be minimized. Alternative embodiments may utilize different manufacturing processes that do not produce holes 322. Thus, holes 322 are not a necessity of any embodiment.

While flame arrestor 300 is illustrated as having a circular profile along its longitudinal axis, it should be understood that the profile of flame arrestor 300 could have other shapes. For example, flame arrestor 300 could have an elliptical profile, rectangular profile, triangular profile, or the like. However, it should be understood that the profile of flame arrestor 300 will be dictated by the profile of the radially inner surface of intake runner 200, which will typically have a circular profile.

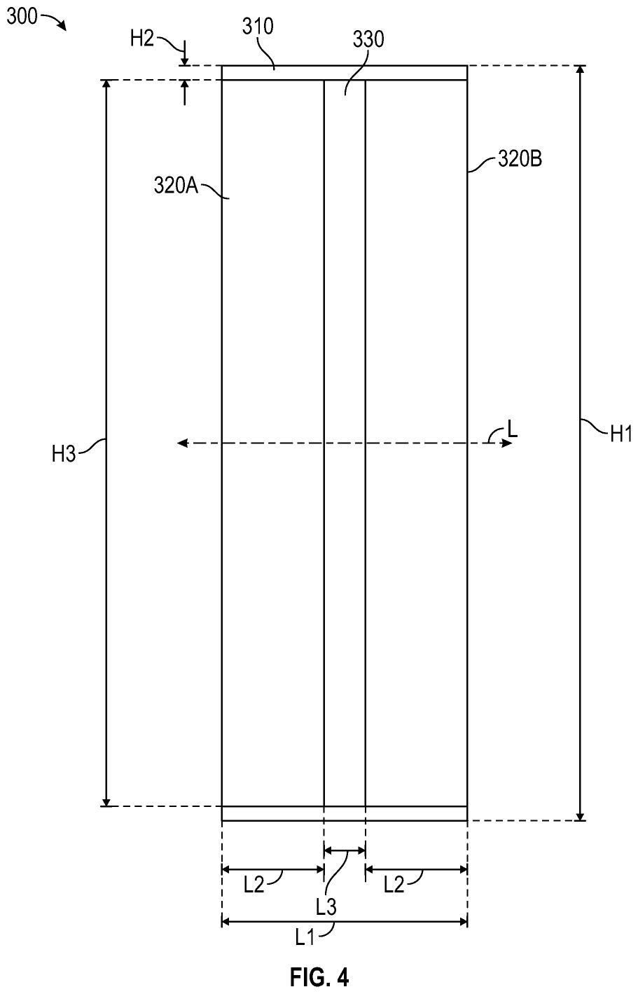

FIG. 4 illustrates a cross-sectional view of flame arrestor 300, cut along line A-A in FIG. 3, according to an embodiment. Line A-A is orthogonal to longitudinal axis L of flame arrestor 300. As shown, there are two substrates 320A and 320B within housing 310. While not necessary, it is generally contemplated that substrates 320A and 320B are identical in structure and dimensions. However, in an alternative embodiment, substrates 320A and 320B could differ in one or more characteristics, such as mesh density, material composition, axial lengths, and/or the like. As illustrated substrates 320A and 320B are spaced apart, along longitudinal axis L, by an air gap 330 that is internal to housing 310 and flame arrestor 300.

Flame arrestor 300 has a height H1 (i.e., orthogonal to longitudinal axis L). Housing 310 has a thickness H2, and each substrate has a height H3. It should be understood that H1=2*H2+H3. Assuming that flame arrestor 300 has a circular profile, height H1 is the outer diameter of flame arrestor 300, H2 is the difference between the inner diameter and outer diameter of housing 310, and H3 is the diameter of substrate 320.

Flame arrestor 300 has an axial length L1 (i.e., parallel to longitudinal axis L), which is also the length of housing 310. Each substrate 320 has an axial length L2. Air gap 330 has an axial length L3. It should be understood that L1=2*L2+L3.

The values of these dimensions in an example implementation are:

| Dimension | Value (millimeters) |
|---|---|
| H1 | 93.0 ± 0.5 |
| H2 | 1.5 ± 0.1 |
| H3 | 90.0 |
| L1 | 29 ± 0.2 |
| L2 | 12.5 ± 0.25 |
| L3 | 4.0 |

In general, the axial length L3 of air gap 330 may be in the range of 1 millimeters to 9 millimeters. The values of the above dimensions may be scaled up or down, while maintaining the relative ratios between dimensions. Alternatively, the axial length L3 of air gap 330 may be maintained at 4 millimeters or in the range of 1 millimeters to 9 millimeters, regardless of variations in the other dimensions, which may or may not maintain their relative ratios to each other. In other words, regardless of the other dimensions, the axial length L3 of air gap 330 may be between 1 millimeters and 9 millimeters, and in a preferred embodiment, substantially 4 millimeters (i.e., between 3.5 and 4.5 millimeters).

In an alternative embodiment, the axial length L3 of air gap 330 may be between 0 millimeters and 1 millimeters. In the event that air gap 330 is omitted (i.e., L3=0 millimeters), it should be understood that flame arrestor 300 may still comprise two separate and distinct substrates 320A and 320B. In this case, substrates 320A and 320B may differ in some characteristic, such that they do not collectively act as a single substrate 320. For example, substrates 320A and 320B may be misaligned, such that there are no straight flow paths through flame arrestor 300, and/or may have different mesh densities, material compositions, axial lengths, and/or the like.

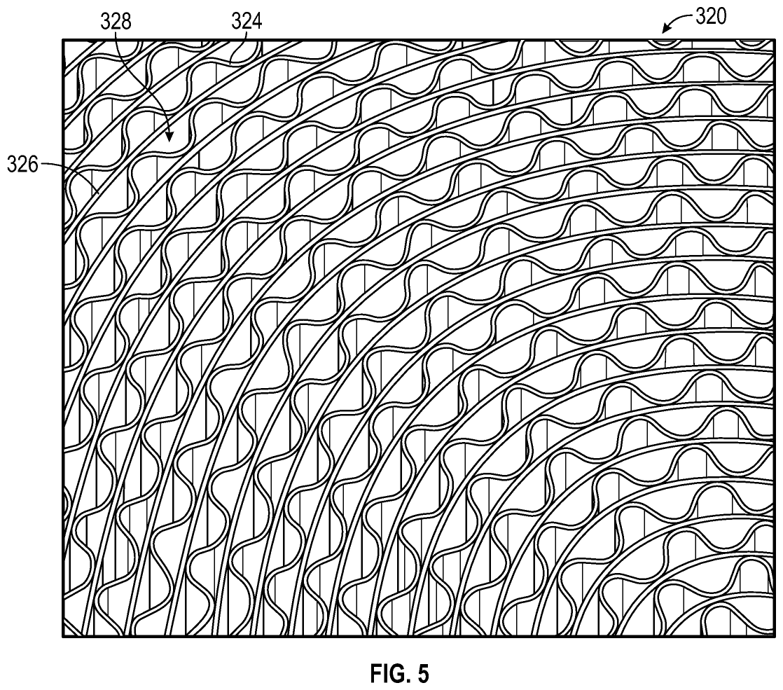

FIG. 5 illustrates a portion of the metallic mesh of substrate 320, according to an embodiment. In the illustrated embodiment, the metallic mesh is constructed by spooling a corrugated ribbon around longitudinal axis L. The corrugated ribbon comprises fluting 324 (i.e., alternating ridges and grooves) welded to a liner 326. When spooled, the corrugated ribbon stacks on itself, radially outward, to sandwich fluting 324 between a pair of liners 326, in a honeycomb-like pattern. The spaces between fluting 324 and liner 326 form a plurality of channels 328 through substrate 320. Channels 328 enable gas (e.g., air) to flow into the upstream end of substrate 320, through substrate 320, and out the downstream end of substrate 320, whereas fluting 324 and liners 326 absorb heat (e.g., from a flame front entering the downstream end of substrate 320). As an example, there may be four hundred or more channels 328 per square inch of substrate 320.

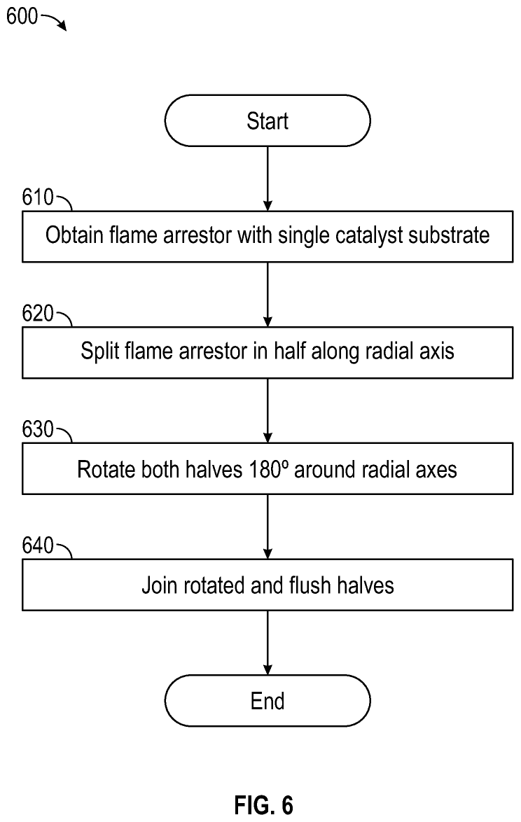

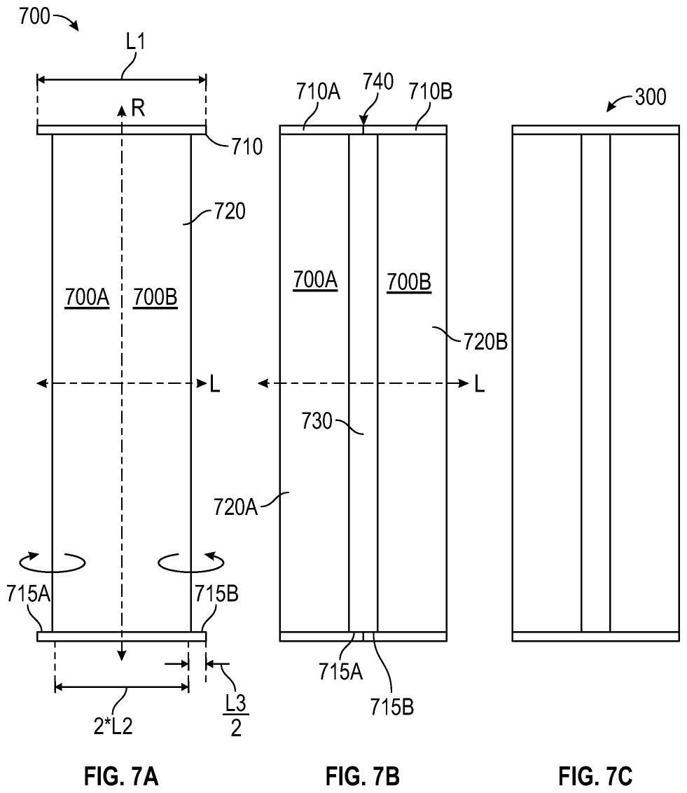

FIG. 6 illustrates a process 600 for manufacturing flame arrestor 300, and FIGS. 7A-7C illustrate the flame arrestor at various stages during manufacturing process 600, according to an embodiment.

Initially, in subprocess 610, a flame arrestor consisting of a single catalyst substrate is obtained. Such a flame arrestor 700 is illustrated in FIG. 7A. Flame arrestor 700 may be a conventional flame arrestor, manufactured according to a conventional manufacturing process. For example, as discussed elsewhere herein, flame arrestor 700 may be manufactured by spooling a corrugated ribbon into a cylinder using mandrels, welding the spooled substrate 720 into a cylindrical housing 710, and furnace brazing flame arrestor 700. Flame arrestor 700 may be acquired as an off-the-shelf component.

Flame arrestor 700 may be chosen or manufactured to have substantially the same axial length L1 as the desired flame arrestor 300. In addition, flame arrestor 700 may consist of a single catalyst substrate 720 that has an axial length that is twice the desired axial length L2. The axial length of single catalyst substrate 720 is less than axial length of flame arrestor 700, such that single catalyst substrate 720 is inset into housing 710 by an axial length that is half the desired axial length L3, on both the upstream and downstream ends of flame arrestor 700. In particular, there is a first spacing 715A from a first end of flame arrestor 700 to the corresponding end of single catalyst substrate 720, and a second spacing 715B from a second end of flame arrestor 700, opposite the first end, to the corresponding end of single catalyst substrate 720.

In subprocess 620, flame arrestor 700 is split in half along a radial axis R, orthogonally to longitudinal axis L, as illustrated in FIG. 7A. This will split flame arrestor 700 into two halves 700A and 700B. Each half 700A and 700B has the same dimensions, with a height of H1 and an axial length that is half of L1. Flame arrestor 700 may be split using any known technique, such as wire electrical discharge machining (EDM).

In subprocess 630, both halves 700A and 700B are rotated 180 degrees around their radial axes. Then, as illustrated in FIG. 7B, housing 710A of first half 700A may be positioned flush with housing 710B of second half 700B, such that the previously open ends of first half 700A and second half 700B are now facing each other. As a result, spacings 715A and 715B, which were previously separate and distinct at opposing open ends of flame arrestor 700, will face each other, such that first spacing 715A and second spacing 715B are contiguous. The contiguous first spacing 715A and second spacing 715B form an internal air gap 730, along longitudinal axis L, between substrate 720A of first half 700A and substrate 720B of second half 700B.

In subprocess 640, halves 700A and 700B are joined together in these rotated and flush positions to form flame arrestor 300, as illustrated in FIG. 7C. For example, housings 710A and 710B may be welded together at annular abutment 740 around the entire circumference of housings 710A and 710B, to thereby affix housing 710A to 710B.

Notably, as a result of splitting substrate 720 and rotating the resulting halves 700A and 700B, the channels in the metallic mesh of the two substrate halves 720A and 720B will become misaligned, relative to each other. In other words, the channels in first substrate half 720A will not align with the channels in second substrate half 720B, such that channels 328 in substrate 320A will not align with channels 328 in substrate 320B. Consequently, flow paths from one end of flame arrestor 300 to the opposite end of flame arrestor 300 will generally not be axially straight (other than possibly in a rare coincidence). More generally, flame arrestor 300 may be constructed such that the plurality of channels 328 in substrate 320A is unaligned with the plurality of channels 328 in substrate 320B, to prevent axially straight flow paths through flame arrestor 300.

While embodiments of flame arrestor 300 are described herein as consisting of two substrates 320, alternative embodiments may comprise more than two substrates 320. For example, flame arrestor 300 may comprise three, four, five, or more substrates 320. In these cases, each pair of adjacent substrates 320 may be spaced apart, along longitudinal axis L, by an air gap 330. It should be understood that, for a flame arrestor 300 with N substrates 320, there will be N−1 air gaps 330.

### INDUSTRIAL APPLICABILITY

Flame arrestor 300 comprises an air gap 330 between at least two substrates 320. The axial length of air gap 330 may be in the range of 3 millimeters to 9 millimeters, and preferably substantially 4 millimeters. Each substrate 320 may comprise a mesh forming a plurality of tightly packed channels 328. In an embodiment, the plurality of channels 328 in one substrate 320A are not aligned with the plurality of channels 328 in the adjacent substrate 320B.

The inventors have discovered that a flame arrestor 300 with air gap(s) 330 and/or unaligned channels 328 quenches backfires of gases containing hydrocarbon and/or hydrogen mixtures, while minimizing pressure drop, in an improved manner relative to flame arrestor 700. Accordingly, disclosed embodiments of flame arrestor 300 effectively quench backfires to prevent a flame from reaching inlet 210 of an intake runner 200.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of apparatus. Hence, although the present embodiments are, for convenience of explanation, depicted and described as being implemented in an internal combustion engine, it will be appreciated that it can be implemented in various other types of engines and machines with air intakes that may experience backfire, and in various other systems and environments. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

What is claimed is:

1. A flame arrestor comprising:
a housing having a longitudinal axis from a first end to a second end;
a first substrate within the housing at the first end, the first substrate comprising a plurality of channels from the first end towards the second end; and
a second substrate within the housing at the second end, the second substrate comprising a plurality of channels from the second end towards the first end;
wherein the second substrate is spaced apart from the first substrate, along the longitudinal axis, by an air gap within the housing.

2. The flame arrestor of claim 1, wherein a length of the air gap, along the longitudinal axis, is between 3 millimeters and 9 millimeters.

3. The flame arrestor of claim 1, wherein a length of the air gap, along the longitudinal axis, is between 3.5 millimeters and 4.5 millimeters.

4. The flame arrestor of claim 1, wherein the plurality of channels in the first substrate is unaligned with the plurality of channels in the second substrate.

5. The flame arrestor of claim 1, wherein one or both of the first substrate and the second substrate comprises a metallic mesh.

6. The flame arrestor of claim 5, wherein the metallic mesh is made of stainless steel.

7. The flame arrestor of claim 5, wherein the metallic mesh comprises fluting sandwiched between liners to form the plurality of channels in the respective substrate.

8. The flame arrestor of claim 5, wherein both the first substrate and the second substrate comprises the metallic mesh.

9. The flame arrestor of claim 1, wherein the housing is cylindrical and each of the first substrate and the second substrate has a circular profile.

10. The flame arrestor of claim 1, wherein the first substrate and the second substrate are identical.

11. An intake runner comprising:
an inlet;
an outlet;
a channel between the inlet and outlet; and
the flame arrestor of claim 1 within the channel.

12. An intake manifold comprising:
a plenum; and
a plurality of the intake runner of claim 11, wherein the inlet of each of plurality of intake runners is in fluid communication with the plenum.

13. An internal combustion engine comprising:
an engine block; and
the intake manifold of claim 12, wherein the outlet of each of the plurality of intake runners is in fluid communication with the engine block.

14. A flame arrestor comprising:
a cylindrical housing having a longitudinal axis from a first end to a second end;
a first substrate within the cylindrical housing at the first end, the first substrate comprising a plurality of channels from the first end towards the second end; and
a second substrate within the cylindrical housing at the second end, the second substrate comprising a plurality of channels from the second end towards the first end;
wherein the second substrate is spaced apart from the first substrate, along the longitudinal axis, by an air gap within the cylindrical housing,
wherein a length of the air gap, along the longitudinal axis, is between 3 millimeters and 9 millimeters, and
wherein the plurality of channels in the first substrate is unaligned with the plurality of channels in the second substrate.

15. The flame arrestor of claim 14, wherein the length of the air gap is between 3.5 millimeters and 4.5 millimeters.

16. The flame arrestor of claim 14, wherein each of the first substrate and the second substrate comprises a metallic mesh, and wherein each metallic mesh comprises fluting sandwiched between liners to form the plurality of channels in the respective substrate.

17. A method of manufacturing a flame arrestor, the method comprising:
splitting an existing flame arrestor, along a radial axis, into a first half and a second half, wherein the existing flame arrestor comprises a housing, having a longitudinal axis from a first end to a second end that is orthogonal to the radial axis, only a single substrate within the housing, a first spacing from the first end to the substrate, and a second spacing from the second end to the substrate;
rotating both the first half and the second half, such that the first spacing is contiguous with the second spacing, so as to form an air gap, along the longitudinal axis, between the substrate in the first half and the substrate in the second half; and
joining the housing of the rotated first half to the housing of the rotated second half to form a new flame arrestor.

18. The method of claim 17, wherein a length of the air gap, along the longitudinal axis, is between 3 millimeters and 9 millimeters.

19. The method of claim 17, wherein a length of each of the first spacing and the second spacing is between 1.75 millimeters and 2.25 millimeters, such that a length of the air gap, along the longitudinal axis, is between 3.5 millimeters and 4.5 millimeters.

20. The method of claim 17, wherein the substrate comprises a metallic mesh.
